(19) United States
(12) Patent Application Publication
(10) Pub. No.: US 2020/0192393 A1
(43) Pub. Date: Jun. 18, 2020

(54) Self-Modification of an Autonomous Driving System

(71) Applicant: Allstate Insurance Company, Northbrook, IL (US)

(72) Inventor: Juan Carlos Aragon, Redwood City, CA (US)

(73) Assignee: Allstate Insurance Company, Northbrook, IL (US)

(21) Appl. No.: 16/711,000

(22) Filed: Dec. 11, 2019

Related U.S. Application Data
(60) Provisional application No. 62/778,472, filed on Dec. 12, 2018.

(51) Int. Cl. G05D 1/02; G06N 3/08; B60W 50/08

(52) U.S. Cl. CPC G05D 1/0221; B60W 50/085; G06N 3/08

(57) ABSTRACT

A autonomous driving system may self-modify based on observation of driving situations encountered after deployment. The autonomous driving system may take exploratory actions in various driving scenarios and may learn from observing outcomes of the exploratory actions. Driver reaction models corresponding to drivers of nearby vehicles may be determined. Learnings may be shared to and/or received from a central system and/or other autonomous driving systems.

### CROSS-REFERENCE TO RELATED APPLICATIONS

This application claims the benefit of and priority to co-pending U.S. Provisional Patent Application Ser. No. 62/778,472, filed Dec. 12, 2018, and entitled “Self-Modification of an Autonomous Driving Vehicle,” the contents of which is incorporated herein by reference in its entirety for all purposes.

### TECHNICAL FIELD

Aspects of the disclosure generally relate to one or more computer systems, and/or other devices including hardware and/or software. In particular, aspects are directed to self-modification of an autonomous driving vehicle.

### BACKGROUND

Some automobiles now provide a feature or mode wherein the automobile can drive itself, in some scenarios. This mode may be referred to as an autonomous driving mode, and may be implemented in an autonomous driving system in the vehicle.

A challenge faced by autonomous driving systems is that, despite all of the effort invested into training artificial intelligence (AI) algorithms and testing in real-world or simulated conditions, there still remain driving scenarios that have not been seen before by the autonomous driving system. Existing autonomous driving systems, when encountering these driving scenarios, may put the vehicle into an unsafe situation or may default to a behavior that some may find unsatisfactory.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In some aspects, a self-modifying autonomous driving system may include at least one processor and a memory unit storing computer-executable instructions. The computer-executable instructions may, in some embodiments, determine predicted states corresponding to each of a plurality of exploratory driving actions and cause the autonomous driving system to invoke one of the exploratory driving actions.

In some aspects, the self-modifying autonomous driving system may determine a plurality of exploratory driving actions, which may include driving actions such as a braking action, initiating a lane merging action, and causing activation of a visual turn indicator.

In some aspects, the self-modifying autonomous driving system may, after causing the autonomous driving system to invoke an exploratory driving action, receive an outcome of the invoked exploratory driving action, and train a deep neural network, based on the outcome.

Of course, the methods and systems of the above-referenced embodiments may also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The present invention is illustrated by way of example and is not limited by the accompanying figures in which like reference numerals indicate similar elements and in which:

FIG. 1 illustrates an example computing device that may be used in a self-modifying autonomous driving system in accordance with one or more aspects described herein.

FIG. 2 is a block diagram illustrating a self-modifying autonomous driving system in accordance with one or more aspects described herein.

FIG. 3 is a block diagram illustrating self-modifying of an autonomous driving system in accordance with one or more aspects described herein.

FIG. 4 illustrates a distributed artificial intelligence center in accordance with one or more aspects described herein.

FIG. 5 illustrates an exemplary method for self-modification of an autonomous driving system in accordance with one or more aspects described herein.

### DETAILED DESCRIPTION

In accordance with various aspects of the disclosure, methods, computer-readable media, software, and apparatuses are disclosed for self-modification of an autonomous driving system. The autonomous driving system may adapt by exploring new driving scenarios in order to obtain information that may be used to modify its AI models and algorithms. These modifications may be incorporated into the system's training (in a parametric or non-parametric manner), thus effectively adding the new scenarios and self-improving.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

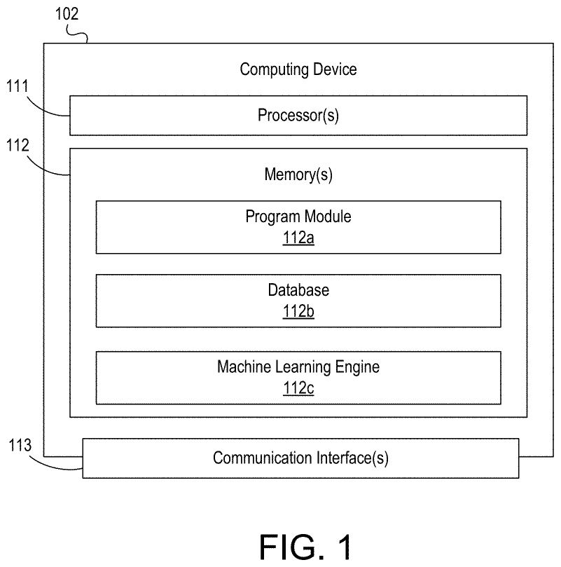

Referring to FIG. 1, a computing device 102, as may be used in a self-modifying autonomous driving system, may include one or more processors 111, memory 112, and communication interface 113. A data bus may interconnect processor 111, memory 112, and communication interface 113. Communication interface 113 may be a network interface configured to support communication between computing device 102 and one or more networks. Memory 112 may include one or more program modules 112a having instructions that when executed by processor 111 cause the computing device 102 to perform one or more functions described herein and/or one or more databases that may store and/or otherwise maintain information which may be used by such program modules and/or processor 111. In some instances, the one or more program modules 112a and/or databases 112b may be stored by and/or maintained in different memory units of computing device 102 and/or by different computing devices that may form and/or otherwise make up the self-modifying autonomous driving system. For example, in some embodiments, memory 112 may have, store, and/or include program module 112a, database 112b, and/or a machine learning engine 112c.

As noted above, different computing devices may form and/or otherwise make up the self-modifying autonomous driving system. In some embodiments, the one or more program modules 112a may be stored by and/or maintained in different memory units by different computing devices, each having corresponding processor(s), memory(s), and communication interface(s). In these embodiments, information input and/or output to/from these program modules may be communicated via the corresponding communication interfaces.

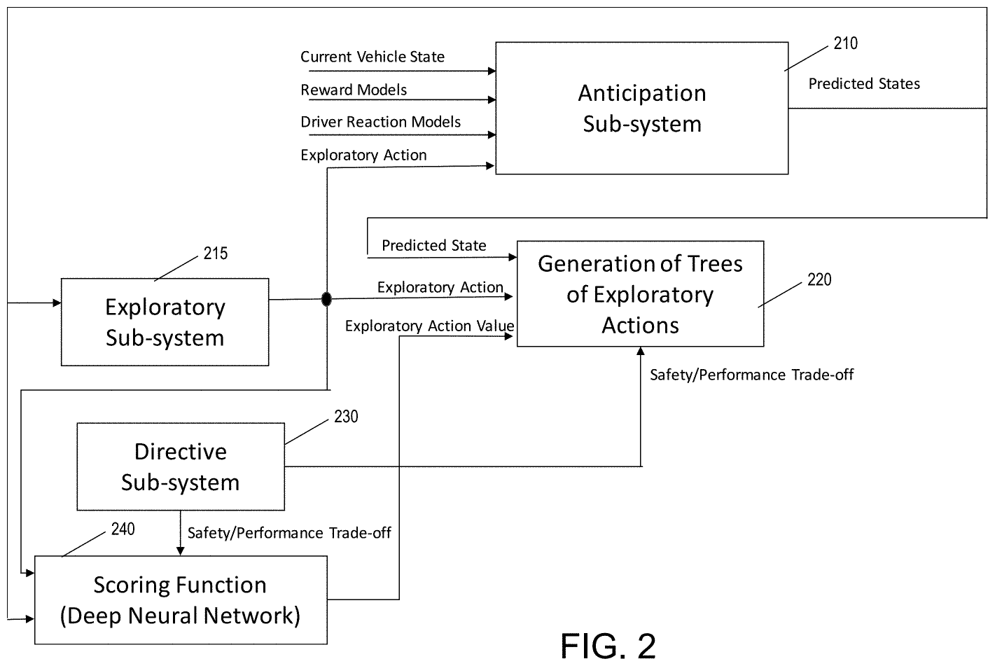

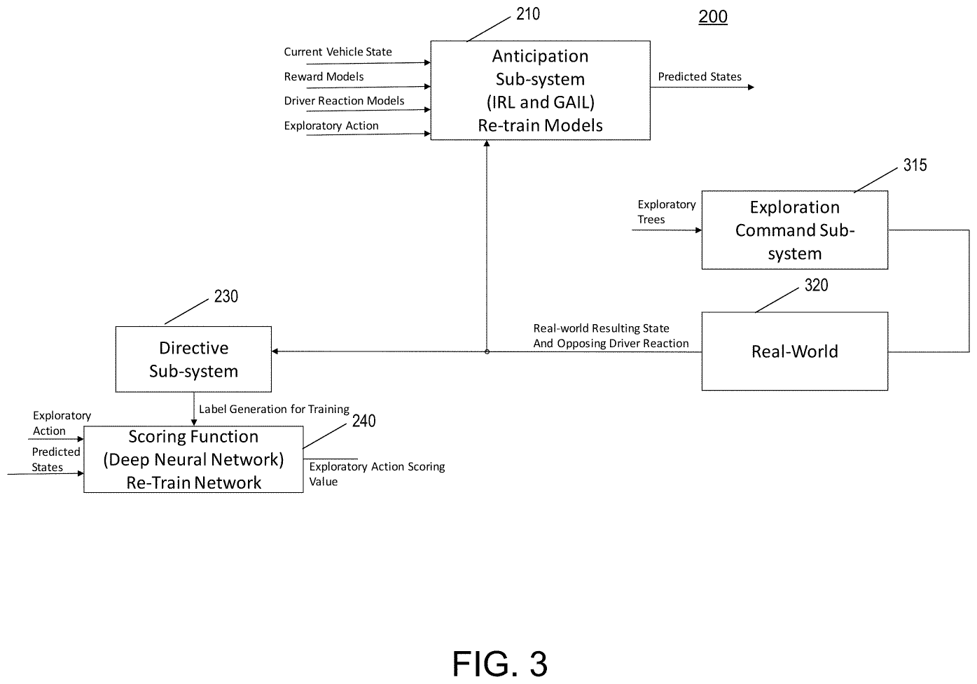

In addition, while FIGS. 2-3 may depict arrangements/organizations of various modules/sub-systems/components of the self-modifying autonomous driving system, those skilled in the art with the benefit of this disclosure will appreciate that other arrangements/organizations of the functions described herein are also possible in accordance with the disclosure.

In some embodiments, an autonomous driving system may, in order to adapt, interact with the environment in ways that allow learning to occur. In some embodiments, the autonomous driving system may explore the environment for unknown scenarios. In such an exploratory mode, the autonomous driving system may, in various embodiments, initiate certain actions that deviate slightly and incrementally from pre-trained actions, in order to explore possible responses and to observe the possibilities for expanding its current set of trained actions for these given scenarios while aiming to achieve the system's goals. This is important, particularly for interactions with human drivers, since such interactions may be complex and diverse in nature and, as such, may not be captured properly, accurately, and completely by the pre-trained autonomous driving models (for example, not all cases to be faced in real-world conditions can be covered in pre-trained models). Exemplary real-world situations may include weather, road conditions, unexpected situations with pedestrians, bicyclists, and other vehicles.

It is beneficial for the autonomous driving system to perform the exploratory driving actions because, under any new driving situation/scenario of interest, if the autonomous driving system fails to act in an exploratory manner when the scenario arises, then the situation may change and could disappear or evolve into another less important scenario, and the opportunity to learn would be lost. One example of this type of scenario is the negotiation that sometimes needs to happen between drivers when an ego-driver (the driver of the autonomous vehicle) needs to merge into another lane. This type of situation may be highly dependent on the type of driver the autonomous driving system needs to negotiate with. If the autonomous driving strategy is to always expect passively an opening to be offered by the opposing driver, then the opportunity to learn the possibilities for interaction with other types of drivers, for example an aggressive driver, may never materialize. In certain autonomous driving systems, without the benefit of exploratory learning, the autonomous driving system might cause the autonomous vehicle miss exits and turns, thus making a trip difficult and problematic.

Additionally, negotiating situations like the above cannot be reproduced on a simulator, because the simulator cannot know with precision what an opposing driver may do if the autonomous driving system acted differently. In some embodiments, the exploratory actions taken by the autonomous driving system may depend on the particular and peculiar reaction of the opposing driver to a previous exploratory action. A simulator cannot simulate with accuracy the reaction of the human opposing driver, and thus this chain of exploratory actions and human reactions cannot be accomplished by the simulator. Therefore, in order to learn from the situation of interest, the autonomous driving system should be given the opportunity to perform exploratory learning.

In terms of exploratory learning, there are at least two aspects for consideration: (A): exploratory actions intended for collecting information that informs driving strategies and actions; and (B): exploratory actions that allow the autonomous driving system to act in a different way, to allow for a different course of action, intended to discover the best actions the system might take. This is particularly important for potential scenarios that become clearly challenging for the autonomous driving system.

In the first case above (A), exploration may be performed to observe reactions from neighbor drivers, so that characteristics about human driver actions may be obtained. In some embodiments, the level of politeness may be assessed by performing the exploratory action of initiating a lane merge, by signaling with the directional light, and observing the reaction of the driver that is behind in the adjacent lane. If such a human driver reacts by accelerating, in order to block a potential lane change to be performed by the autonomous driving system, then it may be assumed that this human driver's politeness level is low, which may inform any future action to be taken by the autonomous driving system while the impolite human driver is around. Similarly, in some embodiments, road conditions may be tested by performing small braking actions, when it is safe to do so, in order to test the frictional coefficients of the road, so that the expected braking power may be known/estimated in case of an emergency.

In the second case above (B), the exploratory action may be intended to correct the actions executed under a situation that may be found to be challenging for the autonomous driving system and that generate outcomes that are considered unsatisfactory (because achieving a goal was unsuccessful) and/or unsafe. These cases may be deemed as mistakes made by the autonomous driving system. The outcome in these mistakes may result due to driving situations not seen before in the training, and/or situations where the pre-trained models may not be accurate and thus need correction through exploratory learning.

Another reason for case B above may be a situation where the outcome is not unsatisfactory however, due to demands of the final user of the autonomous vehicle, a more efficient response is demanded from the autonomous driving system. For example, on a given trip it may be requested that the speed be increased under a moderate level of congestion. Under such a situation, the autonomous driving system may be required to leave its “comfort zone” and engage in changing lanes continuously, in order to improve its current driving speed. In some embodiments, this may require the autonomous driving system to relax safety considerations, in order to increase efficiency.

To perform exploratory actions, in some embodiments, the autonomous driving system may apply problem solving methods that allow it to perform a search on trees of potential actions that the autonomous driving system may take and actions that an opposing driver could take. In some embodiments, the problem of interaction between the autonomous driving system and a human driver may be posed as a game problem, where two agents perform moves which are then applied to achieve a goal, and as a response to the moves of the opponent. In some embodiments, an alpha-beta pruning methodology may be applied to the tree search. The moves may be the actions that the autonomous driving system takes and the actions that the human driver takes. The resulting states generated as a consequence of the actions involve the next state of the ego-vehicle as well as the resulting state of the opposing vehicle, which may be the response offered as a reaction by the human driver to the exploratory action initiated by the autonomous driving system.

In these tree search algorithms, in some embodiments, a scoring function (such as the scoring function 240 of FIG. 2) may be used to evaluate the value of each move made at a given position (for example, the move is the driving action, and the given position in the tree is the state in which the vehicle is in). The scoring function may use as inputs the predicted relative positions between the two vehicles involved in an interaction, relative speeds, inferred goals of both vehicles, absolute speeds of both vehicles, absolute accelerations, and estimated trajectories of all the vehicles in the driving scenario (all of the predicted information, including the inferred goals of all the vehicles is summarized as “predicted states” in FIG. 2).

In some embodiments, the scoring function 240 may be generated as a non-linear regression function that provides, as output, a score which may provide a measure of the benefit for the autonomous vehicle to be in the resulting state, after a driving action has been performed. This scoring function may include a goal that the autonomous driving system had at the moment the unknown situation appeared (this way the system may still try to accomplish the intended goal). The scoring function 240 may be informed initially by a planning algorithm pre-trained for the autonomous driving system, but it could change depending on the reactions from the opposing driver after the exploratory actions are generated.

In some embodiments, the scoring function 240 discussed above may be implemented through a deep neural network (a deep neural network is a neural network with multiple layers). The training process for such a network may involve initially the collection of data that populates the inputs. The data may be collected from real-world trips taken by an autonomous vehicle, and initially no exploratory actions are performed so that data collected for more conventional situations exists. In some embodiments, labels for the neural network may be obtained initially based on a directive sub-system 230 that assesses the level of performance and safety achieved as a result of the outcomes from the driving actions. A “sub-system” is a term of art and as used herein will be readily understood by those having ordinary skill in the art. In some embodiments, inputs that produce a given degree of safety and performance combined may provide the label value for these given inputs. Therefore, the directive sub-system 230 may be thought of as providing a similar function that a reward provides in a reinforcement learning setting. There may be situations, however, where the directive sub-system 230 may modify its criteria to assess the safety and performance, depending on the reactions obtained from the opposing drivers, and in this case the assessment may be performed in a way that could relax the safety assessment so that a greater degree of success in terms of performance could be obtained. To make an analogy to reinforcement learning frameworks, this may be similar to having a variable reward.

In some embodiments, the directive sub-system 230 may be based on rules that are driven by parameters. In one example embodiment of the directive sub-system 230, the rules for safety may evaluate the proximity distance between the ego-vehicle and neighbor vehicles, continuously. Similarly, the directive sub-system 230 may evaluate the time-to-collision to a neighbor vehicle, which is the amount of time that it may take for the ego-vehicle to collide with a neighbor vehicle, if the current heading and speed are maintained constant. In some embodiments, these values, among other metrics of safety, may be weighted by weight coefficients which may generate the safety component of a trade-off function.

The performance component of the scoring function 240 may be generated based on performance metrics which, in some embodiments, may include the desired vehicle speed (which may be a goal of the autonomous driving system), and the preferred lane positioning (because the ego-vehicle may be approaching a scheduled highway exit, according to a planned route), among others. In some embodiments, the performance metrics may also be weighted by coefficients. Initially the coefficients of the safety and performance weights may be set to conservative values that may provide a conservative trade-off between safety and performance.

It should be noted that, in some embodiments, the directive sub-system 230 may provide measures of value for the exploratory action, as a result of the evaluation of the outcomes of the exploratory driving actions that are taken in the real-world. In some embodiments, the outcomes may include the resulting state of all of the vehicles in the driving scenario as well as the particular reaction of the opposing driver in a particular interaction between the autonomous driving system and a neighbor human driver.

In some embodiments, the deep neural network that may provide the scoring function 240 may be trained with the labels provided by the directive sub-system 230, and these labels may be based on real-world evaluations of safety/performance. In some embodiments, the scoring function 240 may provide the ability to interpolate between different predicted states for situations for which a real-world label has not been computed. This is a benefit of having a deep neural network as the scoring function 240, because a scoring value may always be available for any exploratory action and predicted state generated by the exploratory sub-system 215 and by the anticipation sub-system 210 (both discussed in more detail below).

In some embodiments, an anticipation sub-system 210 may provide modeling of potential actions that may be taken by opposing drivers in a variety of situations. In some embodiments, a driver reaction model may anticipate what actions an opposing driver will take in response to the exploratory action. In various embodiments, the modeling of the driver reaction may be based on reward functions obtained through Inverse Reinforcement Learning methods (IRL), or by optimization methods that maximize the probability of observing a given driving action (or sequence of driving actions) by changing the parametrization of the reward function. Thus, the driving characteristics for the opposing drivers may be captured through their reward functions. These reward functions may encompass a variety of components which may involve desired speeds, desired accelerations, politeness levels (which, for example, may be values that characterize the tendency to allow another vehicle to cut-in front or to merge to the opposing driver's lane), among others.

In addition to the reward functions, more specific potential reactive driving actions under a variety of situations may be part of the model for the anticipation sub-system 210. Since there may be a variety of drivers with different driving profiles (for example, overly aggressive, moderately aggressive, and passive, among others) there may be different models for reward functions, and different models for reactive actions that may correspond to the different types of driver's profiles.

In some embodiments, Generative Adversarial Imitation Learning (GAIL) may be used to train the model for reactive actions. In these embodiments, by training through demonstrations of reactive actions, the generative component of the GAIL method may learn to predict the reactive driving actions.

In some embodiments, the anticipation sub-system 210 may initially be trained on a variety of known types of drivers with data that has initially been collected from an autonomous driving system that has acquired video footage from a diversity of drivers going around the different trips that were taken by such an autonomous vehicle. The modeling of IRL may be performed based on the detection, for example via computer vision analysis, of the different driver actions obtained from human drivers captured on the footage. Similarly, reactive driving actions for GAIL training may also be detected through computer vision.

In some embodiments, the different reward functions and reactive driver actions may be categorized through unsupervised learning techniques that detect different clusters of reward functions and reactive actions, which may provide the groupings defining the different types of driver profiles discussed above.

Upon deployment, in some embodiments, the anticipation sub-system 210 may continuously access cameras of the autonomous vehicle and may capture through computer vision detection the different driving actions taken by surrounding drivers, which may provide continuous improvement of the models for driving profiles. In some embodiments, the anticipation sub-system 210 may also include a confidence model, which may provide a probability value that may indicate the level of confidence that the anticipation sub-system 210 may correctly predict the opposing driver actions/reactions under a variety of situations. In some embodiments, this confidence model may be implemented through a Bayesian Network, continuously updated through belief propagation algorithms.

In some embodiments, the system may include an exploratory sub-system 215 which may conduct the search for exploratory actions discussed above. In these embodiments, the tree search may consider initially the current state of the ego-vehicle. This state may involve not only the current position, speed, acceleration, and heading of the ego-vehicle, but also the values for these same attributes for all of the surrounding vehicles. Similarly, the characterization of the driver profile for each surrounding driver, based on the available information obtained (collected for the periods of time the surrounding vehicles are visible), may be part of the information available to the exploratory sub-system 215 and this information may be delivered by the anticipation sub-system 210 via the predicted states. For each possible action, the exploratory sub-system 215 may have available a predicted state, not only for the ego-driver but also for the surrounding drivers. For each action in the tree search that generates a predicted state, the scoring function 240 discussed above may be used to evaluate the resulting safety/performance of the predicted state, which may assign a value to the specific action the exploratory sub-system 215 is generating.

The actions generated by the exploratory sub-system 215 may involve a feasible set of actions, which may consider the physical limitations of the vehicle to perform these actions, as well as the overall dynamic models for the vehicles, which may constrain the driving actions that are possible. In some embodiments, the driving actions generated by the exploratory sub-system 215 may allow for driving actions that may be discrete, rather than continuous (for instance a change in acceleration may be one possible exploratory driving action, however this change may need to be considered from a range of possible acceleration values with a step of 0.5 meters per square second, for example, in between the possible values in the range). In this way, a tree of potential exploratory actions based on the current state of the ego-vehicle may be generated, as depicted by the block named “Generation of Trees of Exploratory Actions” 220 in FIG. 2. This block may, in some embodiments, perform the population of the tree of exploratory actions according to the information on the exploratory actions provided by the exploratory sub-system 215, the predicted states provided by the anticipation sub-system 210, and the scoring values provided by the scoring function 240.

In some embodiments, the directive sub-system 230 may change the coefficients assigned to the different components of the scoring function, for example, in order to relax the safety/performance trade-off and allow a less conservative scoring function that would relax the safety levels so that the values of the exploratory actions may be increased for some driving actions that could improve vehicle performance. In these embodiments, the directive sub-system 230 may generate different trees of actions. For example, one of them may be a very conservative tree, another may be a moderately conservative tree, and another may be a fully exploratory tree (the least conservative). Therefore, the trees of exploratory actions may be considered as different strategies for exploration available to the autonomous driving system. In FIG. 2, this ability to induce different trees for exploratory actions is indicated by the “safety/performance trade-off” arrow that goes from the directive sub-system 230 to the “Generation of Trees of Exploratory Actions” 220.

When the autonomous driving system faces an unseen situation, the anticipation sub-system 210, the exploratory sub-system 215, and the scoring function 240 may work together as described above to generate the trees of exploratory actions available for the autonomous driving system, so that the autonomous driving system may learn from the unseen situation. In some embodiments, the anticipation sub-system 210 may generate predicted states for every possible potential exploratory action the autonomous vehicle may take. The scoring function 240 may be applied to the predicted states and thus generate values that may be assigned to the different actions in the tree. A final exploratory action decision may be taken by the exploration command sub-system 315 (see FIG. 3), which may receive exploratory trees from the “Generation of Trees of Exploratory Actions” 220 of FIG. 2, and select, in some embodiments, the action with the highest value (provided by the scoring function) from the least conservative tree of actions.

After the exploratory action has been taken by the autonomous driving system, a real-world 320 reaction from the opposing driver may happen. This reaction may, in principle, be anticipated by the anticipation sub-system 210, however, the reaction may be completely different to what was anticipated, or the reaction may not have happened entirely as expected. In either case, several adaptations may follow. First, the anticipation sub-system 210 may attempt to re-categorize the opposing driver, if another driving profile fits better the type of reaction that occurred. If the type of reaction was close to the reaction anticipated in the expected driver category, then an adaptation of the reward function and an adaptation of the model of driver reactions may follow. In case of the reward function, this function may be modified to better reflect the driver reaction (for example, using IRL and/or GAIL techniques). Additionally, the confidence model associated with this opposing driver may be updated based on the resulting reaction from the opposing driver (for example, the conditional probability tables of the Bayesian Network may be updated based on the new evidence obtained through the observed resulting reaction). Additionally, the scoring function 240 may be updated/re-trained as well, since the previous value for the specific exploratory action that was taken was based on labels generated through the previous models of the anticipation sub-system 210, and these models have been updated, based on the reaction of the opposing driver. Therefore, a new predicted state as a result of the exploratory action may be generated, and also a new label, since a real-world evaluation has been generated by the directive sub-system 230. The updates/re-training of the involved models is shown in FIG. 3.

In some embodiments, if the reaction of the driver would pose a significantly greater risk to the ego-vehicle than anticipated by the scoring function, then the exploration command sub-system 315 may switch to a more conservative tree of actions, in order to continue the exploratory learning at higher safety levels. The risk information embedded in the scoring function's score value may be obtained from the directive sub-system 230, which may have the real-world evaluation, and may provide a comparative assessment of risk between what happened and the risk related component of the scoring function, which may be obtained by evaluating for risk the predicted state that was produced by the anticipation sub-system 210 before the application of the exploratory action.

In some embodiments, for more general cases of unknown situations (other than those involving interaction with drivers), problem solving may be used to explore driving actions. Disclosed herein is a paradigm that allows the autonomous driving system to deal with different situations, without having to resort to a generalized problem a solver. Combining problem solving with pattern recognition may, in some embodiments, enable establishment of different types of problem categories by clustering different unknown situations into groups. Each group may provide the ability to develop different strategies for problem solving, which may provide different solutions for different problem categories. The different categories may trigger different scoring functions that weight the inputs (which may be based on attributes from the driving scenario, such as positions of all the surrounding vehicles, distribution of speeds, and accelerations, among others) in a different way between different categories of problems. Similarly, in some embodiments, case-based reasoning may be used to develop solutions among different categories of problems that are common among them.

In the explorations performed by the methods disclosed herein, it may be necessary to evaluate the safety of such explorations, in order to assess the level of risk of the explorations. In some embodiments, the risk may be measured based on a predefined model that checks minimum distances to the closest vehicle and/or pedestrian and/or road boundary, as well as limits on acceleration and speed. While the explorations put the vehicle within the safety limits, then the autonomous driving system may be allowed to explore. Similarly, some trade-off may be developed for safety, since an unknown situation that could potentially evolve to become dangerous may warrant performing exploratory actions incurring a temporary risk, in order to avoid a more risky situation that could develop if the current course of action continues. Besides providing the ability to cope with unseen situations, in some embodiments, the exploration may be performed with the objective to increase driving efficiency and/or performance.

In some embodiments, exploration, as discussed above, may incorporate driving actions that move the autonomous driving system in a direction away from repeating past mistakes. Learning from experience may, in some embodiments, involve the ability to exploit the knowledge gained from experiencing the result of non-successful actions. “Non-successful actions,” as used herein, refer to actions that result in a worse situation for the autonomous vehicle, or to actions that are a better situation but still short of a goal.

It should be understood that in exploratory learning, the first actions to be taken by the autonomous driving system may not necessarily be successful, nevertheless the gained knowledge may allow the autonomous driving system to increase the potential for success in subsequent actions. In other words, the gained knowledge from previous experiences may prepare the autonomous driving system to be more successful the next time the same challenging event presents itself. Thus the learning becomes incremental.

In some embodiments, the first time the unknown situation appears, the autonomous vehicle might not apply any exploratory action, however it may store the driving scenario corresponding to the unknown situation, and it may, in some embodiments, process in the background a course of action that can be tried the next time the same unknown situation arises. This allows the autonomous driving system to process exploratory actions, without the constraint of having to respond in real time. In some embodiments, the autonomous driving system may pre-empt the unknown situation, by simulating possible evolutions of the unknown situation under different exploratory actions.

In addition to its own experience, in some embodiments, the autonomous driving system may similarly learn from mistakes made by other surrounding human or autonomous drivers (and/or from their successes), thus learning from their experience. In these embodiments, learning from a solution that is observed as being applied by a surrounding human driver for a problem of interest may be performed through analogical reasoning.

The collection and aggregation of the different types of exploratory learnings that may happen across thousands of individual autonomous driving systems may be used in advancing the general algorithms and models for the overall technology, once these learnings are analyzed and processed in a centralized manner. In some embodiments, the resulting more powerful algorithms and models may then be distributed, for example via system updates, to autonomous driving systems in other autonomous vehicles, thereby accelerating the overall industry technological development. This may thought of as learning from the experiences of other autonomous driving systems, some of which may be far away (in other cities, for example).

In some embodiments, an autonomous driving system may exploit information gained from partial exploratory learnings that may have happened on other autonomous driving systems for the scenarios of interest, capitalize on the gained knowledge of the other systems, and/or continue the exploratory learning that the other autonomous driving systems were not able to finish, thus achieving a goal successfully.

In some embodiments, multiple autonomous driving systems may work together to accomplish a common challenging task, where each system may become an individual intelligent agent sharing knowledge. This realization can effectively deliver a wide system of distributed artificial intelligence. Even though this collaboration may not have been intended when the autonomous driving technology was first conceived, the individual vehicles may be able to solve the common problem through the collaboration.

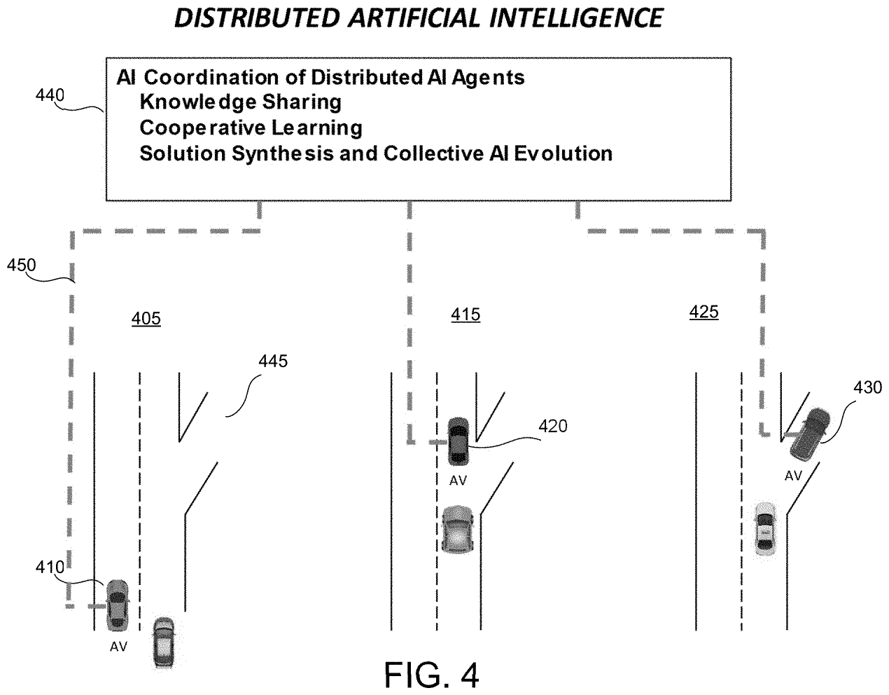

FIG. 4 shows an embodiment of distributed artificial intelligence as discussed above. In this figure, three cases of an autonomous vehicle having the self-modification autonomous driving system as described herein can be seen. In each of the three cases, the goal of the autonomous vehicle (labeled as “AV”) is to take the road exit on the right (and in the three cases we show the same segment of road but with three different AV cars facing the same problem in each case). In the case 405, the AV car 410 could not reach the exit 445, because safety margins of the directive sub-system 230 will not allow it to merge to the right lane (because of the vehicle occupying the right lane). This scenario may be learned by the AV car 410 and reported to the Distributed Artificial Intelligence Center (DAIC) 440. The connectivity between the AV car 410 and the DAIC 440 is indicated by the dashed line 450, and may, in some embodiments, be a wireless connection. The DAIC 440 may analyze the learning scenario and produce a solution that recommends relaxing the safety margins if this situation is encountered again.

The AV car 420 at the center (case 415) may receive from the DAIC 440 the information about the learning scenario discussed above, and implement the recommended solution. In this case 415, the AV car 420 was able to apply the recommended solution and was able to merge to the correct lane, but it narrowly missed the exit. The AV car 420 may report this learning scenario to the DAIC 440, which, after analysis, may generate another solution that recommends relaxing the safety margins a little bit more.

The AV 430 car in case 425 has received the information on the latest learning scenario and the recommended solution. In this case, after relaxing the safety margins by the indicated amount, the AV car 430 is able to successfully exit the highway. Accordingly, different AV cars may work collectively on the same problem by sharing knowledge among them.

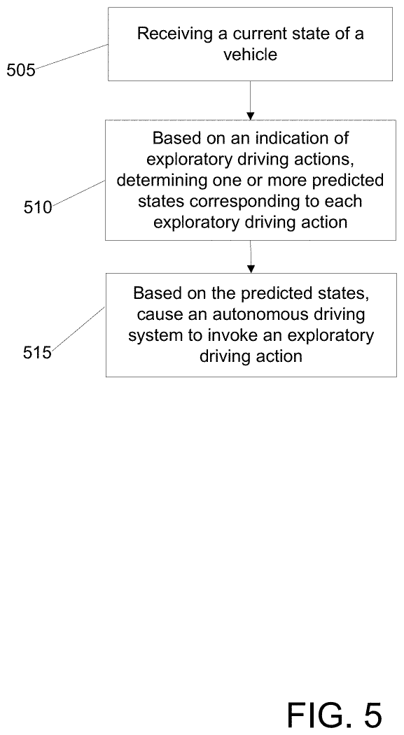

Referring to FIG. 5, at step 505 a current state of a vehicle may be received. In some embodiments, the state of the vehicle may include a current position, a speed, an acceleration, and a heading, among others.

At step 510, for each of a plurality of exploratory actions, one or more predicted states corresponding to the exploratory action may be determined. In some embodiments, predicted states of neighboring vehicles may be determined. In various embodiments, the exploratory driving actions may include one or more of performing a braking action, initiating a lane merging action, and causing activation of a visual turn indicator. In some embodiments, various amounts of lane merging action (for example, merging 10% into the lane, or merging 20% into the lane) may each be considered an exploratory action.

At step 515, based on the predicted states, an autonomous driving system may be caused to invoke one of the exploratory driving actions.

Aspects of the invention have been described in terms of illustrative embodiments thereof. Numerous other embodiments, modifications, and variations within the scope and spirit of the description may occur to persons of ordinary skill in the art from a review of this disclosure. For example, one of ordinary skill in the art may appreciate that the steps disclosed in the description may be performed in other than the recited order, and that one or more steps may be optional in accordance with aspects of the invention.

What is claimed is:

1. A method comprising:
receiving, by a computing device, a current state of a vehicle;
based on an indication of a plurality of exploratory driving actions, determining one or more predicted states corresponding to each of the exploratory driving actions; and
based on the one or more predicted states, causing an autonomous driving system to invoke one exploratory driving action of the plurality of exploratory driving actions.

2. The method of claim 1, further comprising:
determining the plurality of exploratory driving actions, wherein the plurality of exploratory driving actions comprise one or more of performing a braking action, initiating a lane merging action, and causing activation of a visual turn indicator.

3. The method of claim 1, further comprising:
determining driver reaction models corresponding to drivers of nearby vehicles, wherein the determining the one or more predicted states corresponding to each of the exploratory driving actions is further based on the driver reaction models.

4. The method of claim 1, further comprising:
determining reward models corresponding to drivers of nearby vehicles, wherein the determining the one or more predicted states corresponding to each of the exploratory driving actions is further based on the reward models.

5. The method of claim 1, further comprising:
determining, by use of a deep neural network, an exploratory driving action score corresponding to each of the plurality of exploratory driving actions, wherein the causing the autonomous driving system to invoke the one exploratory driving action is further based on the exploratory driving action score.

6. The method of claim 5, further comprising:
after causing the autonomous driving system to invoke the one exploratory driving action, receiving an outcome of the invoked one exploratory driving action; and
training the deep neural network, based on the outcome.

7. The method of claim 6, wherein the determining the one or more predicted states corresponding to each of the exploratory driving actions is further based on driver reaction models, the method further comprising:
updating the driver reaction models based on the outcome.

8. The method of claim 1, further comprising:
after causing the autonomous driving system to invoke the one exploratory driving action, determining an outcome of the invoked one exploratory driving action; and
reporting information indicative of the invoked one exploratory driving action and the outcome.

9. The method of claim 1, further comprising:
receiving information indicative of an exploratory driving action taken by a second vehicle and an associated outcome; and
training a neural network, based on the exploratory driving action taken by the second vehicle and the associated outcome.

10. A computing platform, comprising:
at least one processor;
a communication interface; and
memory storing computer-readable instructions that, when executed by the at least one processor, cause the computing platform to:
receive a current state of a vehicle;
based on an indication of a plurality of exploratory driving actions, determine one or more predicted states corresponding to each of the exploratory driving actions; and
based on the one or more predicted states, cause an autonomous driving system to invoke one exploratory driving action of the plurality of exploratory driving actions.

11. The computing platform of claim 10, wherein the memory stores additional computer-readable instructions that, when executed by the at least one processor, cause the computing platform to:
determine the plurality of exploratory driving actions, wherein the plurality of exploratory driving actions comprise one or more of performing a braking action, initiating a lane merging action, and causing activation of a visual turn indicator.

12. The computing platform of claim 11, wherein the memory stores additional computer-readable instructions that, when executed by the at least one processor, cause the computing platform to determine the plurality of exploratory driving actions by causing the computing platform to:
select at least one exploratory driving action previously associated with a driver reaction model.

13. The computing platform of claim 10, wherein the memory stores additional computer-readable instructions that, when executed by the at least one processor, cause the computing platform to:
determine driver reaction models corresponding to drivers of nearby vehicles, wherein the determining the one or more predicted states corresponding to each of the exploratory driving actions is further based on the driver reaction models.

14. The computing platform of claim 10, wherein the memory stores additional computer-readable instructions that, when executed by the at least one processor, cause the computing platform to:
determine reward models corresponding to drivers of nearby vehicles, wherein the determining the one or more predicted states corresponding to each of the exploratory driving actions is further based on the reward models.

15. The computing platform of claim 14, wherein the memory stores additional computer-readable instructions that, when executed by the at least one processor, cause the computing platform to:
determine, by use of a deep neural network, an exploratory driving action score corresponding to each of the plurality of exploratory driving actions, wherein the causing the autonomous driving system to invoke the one exploratory driving action is further based on the exploratory driving action score.

16. The computing platform of claim 15, wherein the memory stores additional computer-readable instructions that, when executed by the at least one processor, cause the computing platform to:
after causing the autonomous driving system to invoke the one exploratory driving action, receive an outcome of the invoked one exploratory driving action; and
train the deep neural network, based on the outcome.

17. The computing platform of claim 16, wherein the determining the one or more predicted states corresponding to each of the exploratory driving actions is further based on driver reaction models, and wherein the memory stores additional computer-readable instructions that, when executed by the at least one processor, cause the computing platform to:
update the driver reaction models based on the outcome.

18. The computing platform of claim 10, wherein the memory stores additional computer-readable instructions that, when executed by the at least one processor, cause the computing platform to:
report information indicative of the invoked one exploratory driving action and the outcome.

19. The computing platform of claim 10, wherein the memory stores additional computer-readable instructions that, when executed by the at least one processor, cause the computing platform to:
receive information indicative of an exploratory driving action taken by a second vehicle and an associated outcome; and
train a neural network, based on the exploratory driving action taken by the second vehicle and the associated outcome.

20. One or more non-transitory computer-readable media storing instructions that, when executed by a computing platform comprising at least one processor, a communication interface, and memory, cause the computing platform to:
receive a current state of a vehicle;
based on an indication of a plurality of exploratory driving actions, determine one or more predicted states corresponding to each of the exploratory driving actions; and
based on the one or more predicted states, cause an autonomous driving system to invoke one exploratory driving action of the plurality of exploratory driving actions.
